(19) United States
(12) Patent Application Publication
(10) Pub. No.: US 2026/0236477 A1
(43) Pub. Date: Aug. 13, 2026

(54) MULTIMODAL SIMILARITY BASED PROPERTY LISTING PRESENTMENT SYSTEM

(71) Applicant: MFTB Holdco, Inc., Seattle, WA (US)

(72) Inventors: Eric Penner, Seattle, WA (US); Zachary Harrison, Jackson, WY (US); Min Hung Shih, Bellevue, WA (US); Piali Syam, Seattle, WA (US); Zachary Scott Bessinger, Crestwood, KY (US); Lichen Wang, Sunnyvale, CA (US); Anish Khazane, Seattle, WA (US); Saeid Balaneshin, Seattle, WA (US); Ashwani Kapoor, Fremont, CA (US); Naji Khosravan, Seattle, WA (US)

(21) Appl. No.: 19/048,587

(22) Filed: Feb. 7, 2025

(51) Int. Cl. G06F 16/2457; G06F 16/248; G06Q 50/16

(52) U.S. Cl. CPC G06F 16/24578; G06F 16/248; G06Q 50/16

(57) ABSTRACT

A system for presenting property listings allows users to provide express and implicit visual preferences. A profile for the user is built using the visual preferences, which can be used to retrieve property listings matching the visual preferences of the user or to present property listings responsive to a query that most closely match the visual preferences of the user. The system obtains the visual preferences from interactions with images and/or responses to textual prompts. Similarity among vector representations of images associated with a property listing and the visual preferences of the user profile can be used to match property listings to the visual preferences of the user, alone or in combination with other matching criteria.

### BACKGROUND

Property listing search and retrieval systems typically allow users to search and view property listings based on location, as filtered by various tabular factors such as square footage, number of rooms, price, geographic location, and the like. In some cases, such property listing search and retrieval systems may also generate recommendations of properties for a particular user to view based on determined user preferences. Such user preferences are also derived from views and interactions with property listings, which may indicate user affinity for properties based on those tabular factors.

Real estate buyers may have preferred styles and characteristics for houses or particular regions thereof, such as kitchens, master bedrooms or bathrooms, or the like. These styles or characteristics may be reflected in a property listing if included by a listing seller or agent (e.g., “marble countertops” or “arched doorway” or “mid-century modern living room style”). However, this type of textual information is not standardized, and is not typically included in the tabular factors by which a user may filter listings. As such, there is limited ability for property listing search and retrieval systems to account for such characteristics as part of an initial display of properties that may be of interest to a user, let alone how recommendations for other property listings may be generated for a particular user.

### SUMMARY

The present disclosure relates to systems for presenting property listings, for example recommended property listings, based on implicit and explicit preferences of a user relating to visual characteristics of real estate and finding matches for such visual characteristics. Such systems may utilize multimodal systems that capture user preferences associated with both tabular criteria and visual characteristics. By building a profile of a user based on interactions with visual data such as floorplans, images of particular rooms, comments or annotations on such images, and the like, the stylistic preferences of a person searching property listings can be understood. A multimodal model can find matches for such a profile based on representations of images associated with property listings, thus allowing property listings most relevant to the stylistic preferences of the person to be presented to them in search. The multimodal model can order listings retrieved for a search based on tabular factors to present property listings the person searching will have the greatest interest in, while adhering to factors such as geographic preferences, budget, size needs, and the like. This allows a property listing retrieval system to more effectively meet the desires of persons searching for properties by presenting properties matching the visual preferences of such persons.

In an example embodiment, a system for presentation of property listings includes at least one processor and at least one memory. The at least one memory stores a database containing a plurality of image representations. Each of the plurality of image representations is associated with one of a plurality of property listings. The at least one memory further storing instructions that, when executed, cause the at least one processor to direct presentation of an interface on a display, the interface including one or more views and receive an interaction of a user with said one or more views. The instructions further cause the processor to determine a user preference based on the interaction and update a profile of the user based on the user preference. The instructions also cause the processor to direct presentation of one or more property listings of the plurality of property listings to the user based on the profile of the user and one or more of the plurality of image representations.

In an example embodiment, a method for presentation of property listings includes providing, in a memory, a database containing a plurality of image representations, each of the plurality of image representations associated with one of a plurality of property listings. The method further includes presenting an interface on a display, the interface including one or more views and receiving an interaction of a user with said one or more views. The method also includes determining, using a processor, a user preference based on the interaction and updating, using the processor, a profile of the user based on the user preference. The method additionally includes presenting one or more property listings of the plurality of property listings to the user based on the profile of the user and one or more of the plurality of image representations.

In an example embodiment, a system for retrieval of property listings includes at least one processor and at least one memory. The at least one memory stores instructions that, when executed, cause the at least one processor to receive an anchor property listing, determine a plurality of candidate property listings, assign rankings the candidate property listings based on a similarity of image representations associated with respective candidate property listings to image representations of the anchor property listing, and provide at least some of the candidate property listings to a client device based on the rankings.

### BRIEF DESCRIPTION OF THE DRAWINGS

FIG. 1 shows example logical components of a property listing presentation system according to an embodiment.

FIG. 2 shows a flowchart of an example method for presentation of property listings according to an embodiment.

FIG. 3 shows a flowchart of an example method for retrieval of property listings similar to an anchor listing.

FIG. 4 shows example logical components of a property listing retrieval system according to an embodiment.

FIG. 5 shows an example interface in which aspects of the present disclosure may be implemented to receive explicit user feedback regarding visual preferences in a listing.

FIG. 6 shows an example collection of datasets of property listings including tabular listing criteria and images from which determinations of visual similarity may be drawn.

FIG. 7 shows an example flow diagram of processing user preferences derived from one or more anchor listings to generate similar listings for presentment to a user.

FIG. 8 shows an example user interface in which property listings having similar visual characteristics to those associated with a user profile may be presented.

FIG. 9 illustrates an example computing device with which aspects of the present disclosure may be implemented.

### DETAILED DESCRIPTION

The present disclosure relates to systems for presenting property listings based on implicit and explicit preferences of a user relating to visual characteristics of real estate and finding matches for such visual characteristics. Embodiments of the present disclosure allow for a property listing system to develop a profile indicative of a user's visual and stylistic preferences regarding properties, based on explicit and implicitly stated preferences of the user directed to not only tabular criteria such as but also visual characteristics such as appearance of all or a portion of a particular listing.

Such appearance-based characteristics may be, for example, an overall appearance of a property (e.g., the exterior façade), a style or appearance of an individual room (e.g., a modern kitchen or bathroom), or detailed, specific features of a room (e.g., granite or marble countertops, a golden toilet, or the like). As described further below, a user may explicitly state a preference for such features by way of text feedback, “liking” a particular listing or image, lingering on a particular image or listing for an extended period of time, or a combination thereof.

The created user profile in turn allows a property listing search and retrieval system to account for these preferences when presenting property listings, for example recommended property listings that are selected and personalized to a particular user. This selection and personalization may be performed in realtime for display in a user interface to the user based on up-to-date stated user preferences, for example based on precomputed visual embeddings combined with capture of user interest information. This allows for fast retrieval and return of more relevant and helpful results to the user in accordance with their particular visual and stylistic preferences, as opposed to just matching text and structured input of a query (for example, matching square footage, location, or the like) without accounting for appearance or style. Embodiments of the present disclosure thus improve the search and retrieval of property listings for a user and add the capability for automated discovery of visual preferences and application of such preferences to the search, retrieval, and/or presentation of property listings.

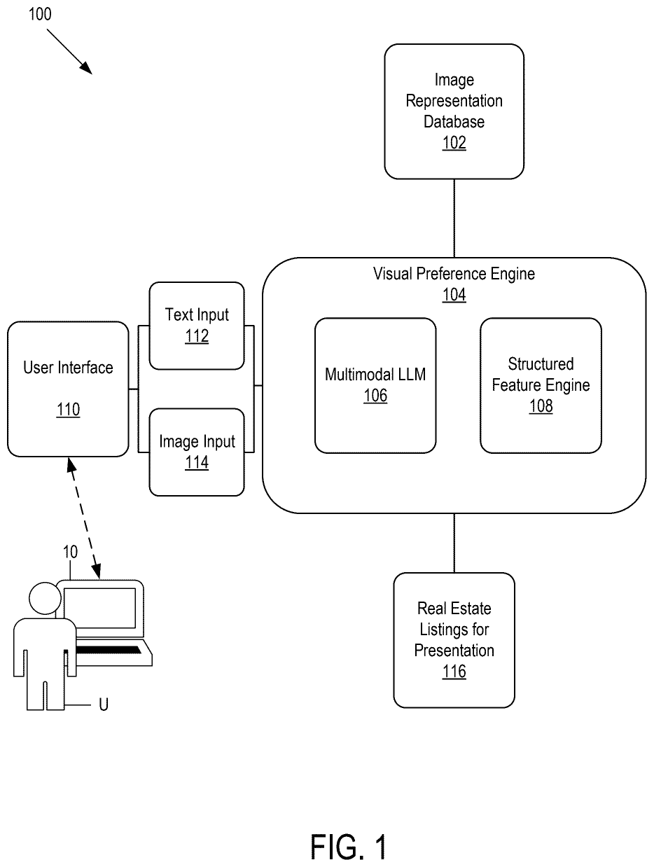

FIG. 1 shows example logical components of a property listing presentation system according to an embodiment. Property listing presentation system 100 includes image representation database 102 and visual preference engine 104. The visual preference engine 104 can include multimodal large language model (LLM) 106 and structured feature engine 108. User interface 110 can be provided, for example to a user device 10 of a user U, and text inputs 112 and/or image inputs 114 can be obtained through user interface 110 as described in further detail below. The visual preference engine 104 can determine property listings for presentation 116.

Property listing presentation system 100 is configured to present a user with property listings responsive to a query by the user and/or a profile of the user. The query by the user may be, for example a query to view a variety of listings, or may be a selection of an initial listing, in a user interface that displays other similar listings based on the user's preferences as reflected in the profile of the user.

The profile of the user can include information regarding tabular preferences of the user, for example specific metropolitan areas (e.g. cities, ZIP codes, and the like), price ranges, property size, amenities (e.g., number of bedrooms and bathrooms) and other types of tabular and categorizable information of the user. This information may be gathered explicitly from the user, or implicitly from historical search patterns of the user.

The profile of the user may also, in accordance with the present disclosure, include visual preferences of the user, for example based on interactions with images presented to the user, user responses to textual prompts, and/or user responses to combinations of images with textual prompts. The property listing presentation system 100 can be integrated into or used with a property search and retrieval system configured to search a database of property listings and retrieve results responsive to a query. In an embodiment, property listing presentation system 100 ranks or orders results obtained by the search and retrieval system according to the profile of the user. In an embodiment, property listing presentation system 100 works with or is integrated into the search and retrieval system such that the retrieval of property listings from the database is based at least in part on the profile of the user, in addition to the query.

Image representation database 102 contains images associated with property listings or representations thereof. A non-limiting example of a representation of an image is a vector representation of the image. In an embodiment, the representations in image representation database 102 can include aggregations of scenes obtained from a plurality of images, for example aggregating a plurality of images all showing a kitchen of a property, or the like. Images can include embeddings describing those images. The embeddings may, for example, associate the images or representations thereof with particular scenes, for example identifying the image as a view of a kitchen, living room, bathroom, master, guest, or secondary bedroom, or the like. The number of classifications that can be embedded in the image representations can be selected based on importance of scenes to users. For example, scene classifications can be provided for key rooms significant to users viewing property listings. Scene classifications can be performed using a suitable model, for example a CLIP model. The classifications can correspond to predetermined scene classifications, such as identifying the images as being of particular rooms. In an embodiment, only selected key rooms have corresponding scene classifications that can be associated with images in the image representation database 102. Images in the image representation database 102 can include other embeddings providing additional levels of granularity for categorizing the images, describing particular elements in the images, or the like. In embodiments, the image representations can include identifications of specific features or objects included in the image, for example particular countertops, bathtubs, identification of windows or the number and/or size thereof, or the like.

Representations of images stored in the image representation database 102 can be generated through any suitable method or combinations thereof, with non-limiting examples including contrastive language-image pretrained (CLIP) models, scene aggregation, feature extraction such as histogram of gradients or other such techniques, generation of feature vectors, and the like. Scene aggregation can include aggregation of multiple images identified as being directed to the same scene to generate a representation corresponding to the scene based on the aggregated images. In an embodiment, the features of the aggregated images are averaged to form the representation of the corresponding scene.

In an embodiment, the image representation database 102 can store the images by themselves, with the generation of representations from images being performed when those images may be used by multimodal LLM 106. Images themselves may be stored instead of or in addition to representations in the image representation database 102. Images may be stored by themselves without the corresponding representations in image representation database 102, for example, when the storage costs for storage of representations would exceed the processing costs for generating the representations on demand. In such embodiments, representations such as aggregated scenes, vector representations, or the like can be generated when needed based on the stored images from image representation database 102.

Visual preference engine 104 is configured to determine a user profile of the user's visual preferences and to apply the visual preferences of the user profile to control presentation of property listings to the user. The visual preference engine 104 is configured to process inputs such as text inputs 110 and image inputs 112 to determine a user profile including visual preferences of the user. The user profile can include one or more vectors representative of the expressed and implicit preferences of the user determined based on the inputs. In embodiments, the user profile can include visual preferences specific to individual scenes such as a preferred style for a kitchen, bathroom, master bedroom or the like, indicating preference for particular elements or objects such as particular countertops, bathtubs, or the like. The visual preference engine 104 can further be configured to determine similarity of images associated with property listings to the preferences included in the user profile. A non-limiting example of determining similarity between the images associated with property listings and the preferences of the user profile can include determining cosine similarities between one or more vector representations of the images of a property listing or scenes composed by aggregation thereof, and one or more vectors representative of the preferences of the user. The determination of similarity can be performed using a suitable model such as, for example, a Catboost classifier model.

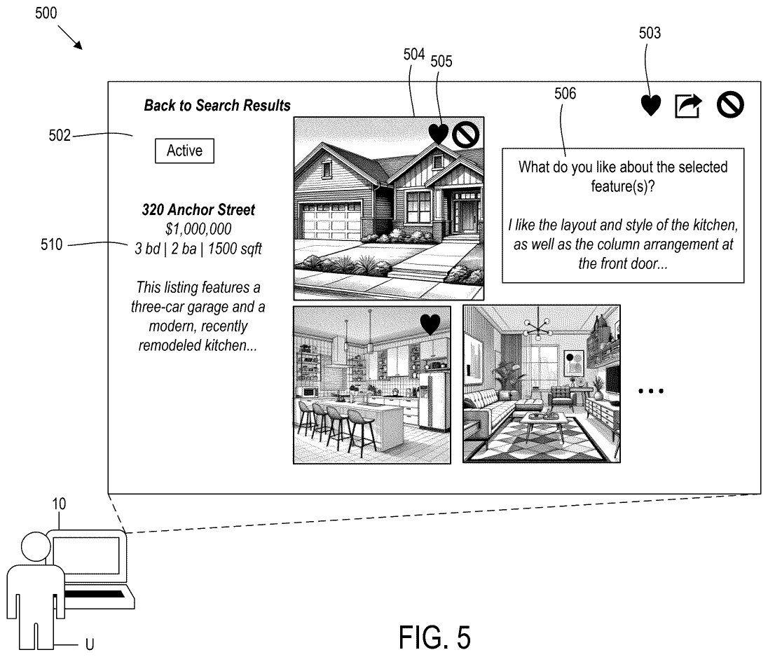

Multimodal LLM 106 is an artificial intelligence model configured to receive, process, and output both textual and image information. Multimodal LLM 106 can process inputs to incorporate user feedback such as text, sentiment, and interaction data into the profile of user visual preferences. For example, multimodal LLM 106 determine whether textual input or other user interactions are providing positive or negative feedback. In some instances, multimodal LLM 106 can associate user interaction feedback with image embeddings such as particular identifications of scenes, features of the image, or the like. In some instances, multimodal LLM 106 can process the received user interactions to identify the aspects of the representations defining the user profile to be updated based on those received user interactions. In embodiments, multimodal LLM 106 can include a foundation model, a vision language model, a vision classifier, a fully multimodal model, or the like. Non-limiting examples of models capable of being used as the multimodal LLM 106 include GPT-40, LLaVa, Ferret, Claude, Gemini, Kosmos-2, or the like. The multimodal LLM 106 is configured to process text inputs 112 and image inputs 114 so as to determine and update a user profile. The processing of the text inputs 112 and image inputs 114 can define one or more vectors representative of the user preferences for the user profile, based on the text inputs 112 and/or image inputs 114 and the characteristics of images presented to the user through the user interface 110 when eliciting said inputs. In an embodiment, multimodal LLM 106 can generate textual prompts for eliciting user input to refine the user profile. For example, the multimodal LLM can generate a textual prompt for the user to respond to. An example of textual prompts and user response thereto is shown in text interaction field 506 of FIG. 5 and discussed below.

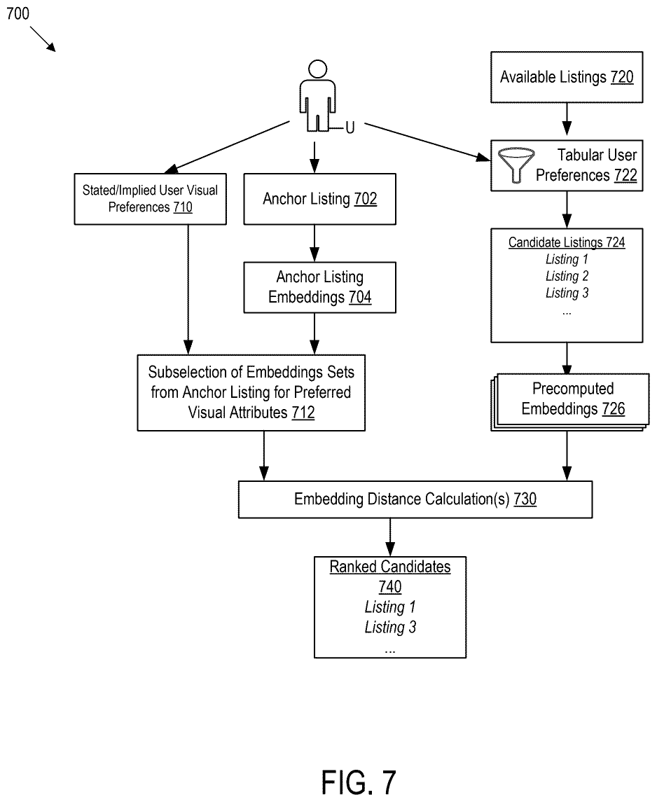

Structured feature engine 108 can be included in the visual preference engine 104. The structured feature engine can receive and process structured features, such as queries or portions thereof relating to tabular metrics such as square footage, geographic location, numbers of bedrooms and/or bathrooms, list price, and the like. Structured feature engine 108 can contribute to the determination of property listings for presentation 116 by retrieving the property listings or filtering the property listings based on the structured features. In an embodiment, the visual preference engine 104 can disregard satisfaction of the structured features or allow a certain extent of departure from the structured features when the similarity to of image representations of the property listing to the user profile exceeds a threshold. An example of such a process of using structured features and visual similarity is illustrated and described below in conjunction with FIG. 7.

User interface 110 is configured to present images to the user and to receive the text inputs 112 and/or image inputs 114. The user interface 112 can be presented, for example, on a display of a computer (e.g. computing device 10) showing a website, a mobile application on a mobile device, or the like. In an embodiment, user interface 110 can require a login, track a session, or otherwise associate the user operating the user interface 110 with a particular user profile so as to determine and store the user's preferences including the visual preferences determined by visual preference engine 104.

Text inputs 112 are textual inputs provided by the user. In an embodiment, the text inputs 112 include textual responses to textual prompts generated by multimodal LLM 106, an LLM, or the like. The textual responses to such prompts can be provided to multimodal LLM 106 to be processed so as to be used in updating the user profile. The textual responses can be used to modify stored user preferences. For example, textual responses included in text inputs 112 can be used to weight the features of an image presented to the user for updating the user profile, to determine positive or negative reactions of the user to the feature for updating the user profile, to obtain information regarding the relationships of particular features relevant to user preferences, and the like. In an embodiment, the text inputs 112 can include query inputs including structured data for use by structured feature engine 108, such as text identifying desired size (square footage, numbers of rooms such as bedrooms/bathrooms, lot size, etc.), location, price range, or otherwise providing structured data regarding properties of potential interest to the user.

Image inputs 114 are interactions of the user with images presented by the visual preference engine 104. The interactions can include clicks such as selections of favorited views or properties, or other metrics such as dwell time, zooming on particular portions of images, or any other such non-textual responses to the images that can be obtained from the user interface 114.

Property listings for presentation 116 are selected and/or ranked by visual preference engine 104. In an embodiment, the visual preference engine 104 can determine an order in which the property listings 116 are to be presented. The property listings 116 can be obtained by a search and retrieval system, by the structured feature engine 108 identifying listings meeting the structured features input by a user, or the like. In an embodiment, property listings 116 can be ordered according to similarity of images associated with the respective listings 116 to the preferences of the user profile by, for example, the multimodal LLM 106, a classifier model such as Catboost, or the like. In an embodiment, the visual preference engine 104 can filter out listings having a similarity below a cutoff value to determine the set of property listings for presentation 116. In an embodiment, at least some of the property listings for presentation 116 can be selected even if the listings do not satisfy at least some of the structured features input by the user when the similarity to the user profile exceeds a threshold amount, when the differences in structured features are within certain ranges of tolerance, or the like. The property listings for presentation 116 can be presented to the user U through user interface 110.

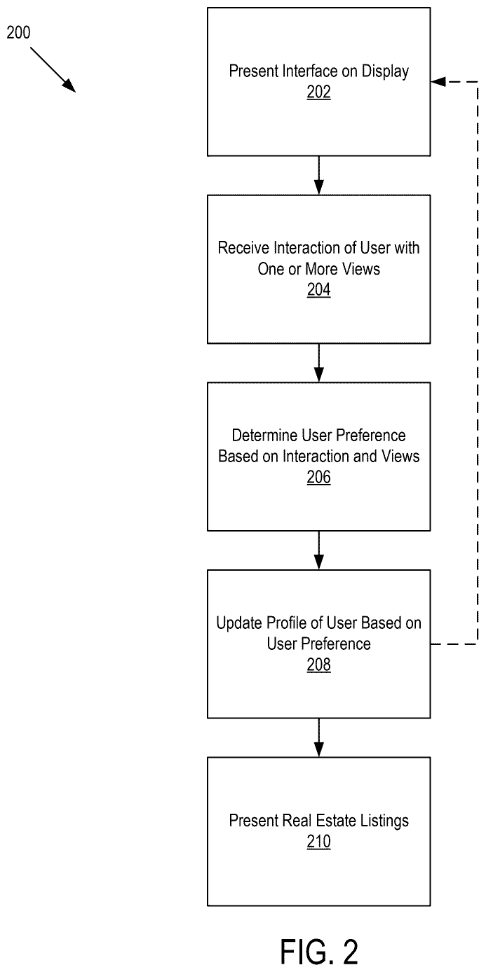

FIG. 2 shows an example method for presentation of property listings according to an embodiment. Method 200 includes presenting an interface on a display (step 202), receiving an interaction of a user with said one or more views (step 204), determining a user preference based on the interaction (step 206), and updating a profile of the user based on the user preference (step 208). The method further includes presenting one or more property listings of the plurality of property listings to the user (step 210).

In an example of the method 200, an interface is presented on a display (step 202). The display can be, as non-limiting examples, a computer screen, a mobile device screen such as a tablet or smartphone, or the like. The interface can be presented by way of a website, a mobile device application, or the like. The interface presented can include at least one image. In an embodiment, the at least one image is associated with a property listing. In an embodiment, the at least one image is associated with a property listing satisfying a query input by the user to a property listing search and retrieval system. Optionally, the interface presented can further include a textual prompt. The interface presented on the display can include one or more interactable items, text boxes for receiving textual input, or the like. In an embodiment, the interface is a property listing for a property that has been selected by the user, for example from a list of property listings provided in response to a user query, from a set of property listings recommended to the user, or the like.

In an embodiment, the image presented on the display at step 202 is selected based on a user profile, for example to discover or confirm visual preferences of the user. For example, an image can be selected based on potential impacts on confidence intervals for one or more preferences in the user's profile, based on areas where preferences have not been determined, or the like. In an embodiment, the image can be selected based on a potential reduction in search space for the preferences of the user. In an embodiment, the image can be selected to obtain preferences regarding characteristics of a particular scene such as a specific room, for example a bedroom, bathroom, kitchen, or the like, to obtain preferences regarding exterior views such as architectural style, views such as a backyard view of a property, or the like. The image can be selected to refine stylistic or feature preferences within a scene, such as type and number of bathroom sinks, presence of a kitchen island, features thereof such as sink placement in a kitchen, specific objects in the scene such as a specific shape, color and/or material for a countertop or a specific style of bathtub, and the like.

An interaction of a user with said one or more views is received (step 204). Interactions can be received through any suitable interface and/or devices allowing the user to provide one or more inputs. Interactions received can include one or more of interaction with an interactable feature of the interface, a text input, a dwell time on an image or a portion thereof, zooming on a portion of the image, or any other click or other interaction with or responsive to the interface presented at step 202 that can be captured. The interaction can include one or both of an explicit expression of the user's preferences, or an implicit expression of the user's preferences. Non-limiting examples of interactions providing explicit expressions of user references can interactions with interactables such as a “like” or “dislike” button associated with an image, providing a rating of an image, providing textual input responsive to an image and/or a textual prompt, or the like. Non-limiting examples of interactions providing implicit expressions of user preferences can includes zooming, dwell time, or the like.

A user preference is determined based on the interaction (step 206). The interaction of the user received, e.g., at step 204, can be processed to determine preferences being expressed by the user. The preferences can be determined based on characteristics of the image presented in the interface, for example a vector representation of the image, descriptive tags for the image or styles or objects included therein, a scene the image is associated with, and the like. The preferences can further be determined based on the interaction of the user received at step 204, such as saving a displayed property listing, liking or disliking the image, processing of textual input by the user, and the like. The processing of textual input by the user can include, for example, determining the presence of keywords, processing by a language model such as an LLM included in multimodal LLM 106, or the like. In an embodiment, the preferences determined at step 206 are expressed, either in whole or in part, as a vector, with characteristics of the vector based on the image presented and the interaction received. Contributions of inputs such as like/dislike interactions or textual inputs to the characteristics of the vector can be weighted based on data present in the profile of the user.

The profile of the user is updated based on the user preference (step 208). The profile of the user is associated with the user through, for example, a user login, browser cookies, data stored in a mobile application, or the like. The profile of the user stores preferences of the user determined through interactions with images and optionally further with textual prompts. The user profile can include preferences specific to particular scenes such as one or more key rooms, for example including preferences particular to one or more of kitchens, bathrooms, master bedrooms, etc. The preferences determined at step 206 are incorporated into the user preference, for example by way of narrowing of confidence intervals regarding particular preferences in the user profile, addition of preferences to the user profile, modification of weightings or intensities of preferences, or the like. In an embodiment, the user profile is expressed as one or more vectors. The vector(s) of the user profile can be updated by addition of one or more respective vectors representative of user preferences as determined at step 206 based on the interaction received at step 204.

One or more property listings of the plurality of property listings are presented to the user (step 210). In an embodiment, the property listings are presented in an order based on the extent to which the listings match the user profile. In some examples, the property listings ordered and presented can be determined based on search and retrieval performed in response to a user query. For example, a user can provide a query including a desired location, size such as square footage and/or numbers of various types of rooms, price range, and the like, and the property listings can be retrieved from a database based on the query. The property listings ordered and presented can also, or alternatively, be determined based on a search and retrieval process performed in response to display of a particular user interface, for example a customized home page selected for the user or display of “related” properties within a property listing page.

The property listings obtained by search and retrieval can have images or aggregated scenes associated with the listing compared to the user preferences to determine a similarity to the user preferences. In an embodiment, vector representations of images or aggregated scenes can be compared to a vector representative of user preferences. The similarity can be determined, for example a cosine similarity between the vectors, a dot product similarity, or the like. The similarity scores can be used to rank the property listings and determine the order in which the property listings are shown to the user in response to the query. In an embodiment, the similarity can be determined using a suitable model, such as a Catboost classifier model. The use of similarity to the user profile can result in the user being shown responsive listings most aligned with their visual and stylistic preferences without requiring intensive review of numerous listings. In an embodiment, property listings having a similarity score below a cutoff value can be omitted from the results presented to the user at step 210.

In an embodiment, the presentation of the property listings to the user at step 210 can include processing the images associated with the listings, for example to aggregate multiple images into a scene and/or to determine a representation for an image or aggregated scene, such as a vector representation thereof. The aggregation and/or determination of the representation can be performed only for listings responsive to the query. Performing the aggregation and/or determination of representations in response to a query as opposed to keeping such aggregations or representations in storage, such as in image representation database 102 of FIG. 1, can reduce the storage space required for storing the images and aggregations and/or representations thereof, in exchange for requiring additional processing to be performed at the time the query is performed. The balancing of storage and processing and the timing of processing of images to scenes and/or representations can be based on relative costs, system capabilities, effects on user experience such as time to receive responses to queries, and the like.

In an embodiment, the search and retrieval of property listings to be presented to the user can be based at least in part on the user profile and image representations associated with respective property listings. As a non-limiting example, vector representations of at least some images or aggregated scenes thereof associated with the respective property listings can be compared to one or more vectors included in the user profile to determine similarity such as a cosine similarity or a dot product similarity. The similarity results can be used to identify property listings responsive to the search by the user. In an embodiment, the property listings can additionally be filtered by structured query inputs such as location, size, price range, and the like before being presented to the user at step 210. In an embodiment, the similarity determination can include the structured query inputs and extent of deviation therefrom. In an embodiment, the similarity can be determined using a suitable model, such as a Catboost classifier model. In an embodiment, the search and retrieval of property listings can include a selection of candidate properties by the retrieval system, based for example on listing attributes. The candidate properties can then be ranked based on visual similarity to the user profile for presentation to the user. The ranking of the candidate listings can be performed using one or more of, for example, K-nearest neighbor, approximate nearest neighbor, or similar approaches.

In an embodiment, steps 202-208 of the method 200 can be performed iteratively to develop the profile of the user prior to the profile being used in the presentation of property listings at step 210. In an embodiment, the iterations can continue until the profile is sufficiently developed, for example based on one or more of the number or variety of preferences included in the profile, the confidence intervals for preferences included in the profile, a number of interactions used to build the profile, or the like. Iteration of steps 202-208 can include iterations of presenting textual prompts and receiving text responses from the user, for example through a chat window provided on the website, in the mobile application, or the like. The iteration of steps 202-208 can include presenting the same image while providing a plurality of different textual prompts to the user across the repeated steps 202, for example to receive input at 204 identifying particular aspects or intensities of the user's preferences being expressed with respect to the image through such input.

In an embodiment, at least some query fields can be provided prior to the presentation of the interface at step 202. For example, a user can input one or more of a desired location, price range, size, or the like. Images to be presented in the interface displayed in conjunction with step 202 can be selected based on the associated property listings satisfying one or more of the query fields. As a non-limiting example, images associated with property listings outside of a user's price range could be excluded from the images presented in the interface, thus ensuring the user preferences can be satisfied by listings within their specified price range. In an embodiment, the selection of images presented can be performed without respect to at least some of the query fields, for example, to determine a user's stylistic or visual ideals without being constrained by price range, location, or the like.

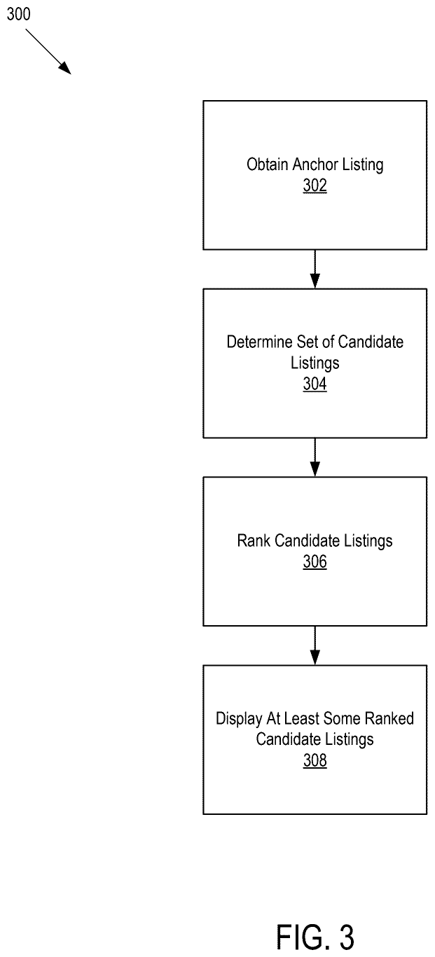

FIG. 3 shows an example method for retrieval of property listings having characteristics, including visual characteristics that are similar to those of an anchor listing. In this context, an anchor listing may represent a listing that is associated with user feedback, whether implicit or explicit, regarding specific preferences for visual characteristics of particular scenes, or of the listing overall. The method 300 may be performed, for example, as part of presentation of real estate listings, as described above in conjunction with step 210 of FIG. 2, and may be performed using system 100 shown in FIG. 1. In the example shown, method 300 includes obtaining the anchor listing (step 302), determining a set of candidate listings (step 304), ranking the candidate listings (step 306), and displaying at least some of the ranked candidate listings (step 308).

In the example method as illustrated, an anchor listing is obtained (step 302). The anchor listing can be a property listing currently being viewed by a user. In an embodiment, the anchor listing can be defined by further user interaction, such as clickstream or other such data, for example saving the property as a favorite, scrolling through the listing to a certain point, or other such interactions. Obtaining the anchor listing can include obtaining the image representations and optionally other attributes of the anchor listing such as location, size such as square footage, numbers of rooms, price, and the like.

In the example shown, the method 300 includes determining a set of candidate listings (step 304). The set of candidate listings can be determined based on similarity to the anchor listing, including similarity of the image representations and optional other attributes. A non-limiting example of determining the set of candidate listings at step 304 includes using a K-nearest neighbor similarity-based approach to determine property listings within a specified cosine distance of the anchor listing, using characteristics of each respective listing in comparison with the characteristics of the anchor listing. For example, the cosine distance between the anchor listing and candidate listings may based on the image representations and optional other attributes thereof. For example, the cosine distance may be based on visual similarity between specific visual characteristics of the anchor listing identified as being of interest to the user (e.g., as received implicitly or explicitly within a user interface such as shown in FIG. 5) and candidate recommended listings that otherwise fall within parameters associated with tabular characteristics of the listings (e.g., being of similar price, size, amenities, and the like).

In some implementations, the set of candidate listings is generated without regard to visual similarity; rather, the candidate listings can be determined based on tabular characteristics of the property listings such as location, price, square footage, numbers of bedrooms and/or bathrooms and the like, and the extent to which those tabular characteristics fall within a range of preferences previously identified for the user. For example, the candidate listings can be determined by retrieving property listings that have tabular characteristics within permissible thresholds of deviation from the corresponding tabular characteristics of the anchor listing, or within permissible thresholds of deviation from a range of characteristics that are identified as being preferred for the user. Examples of thresholds of deviation can include a predetermined distance from the location of the anchor listing, flat or percentage deviations from the square footage or the price of the anchor listing, or the like. In an embodiment, a classifier, such as the Catboost classifier, a gradient boosting classifier, or the like can be used for the determination of candidate listings.

The set of candidate listings determined are ranked (step 306). The ranking can be based on the similarity of the candidate listings to user preferences, for example those included in a user profile, based on the image representations and other attributes. The similarity can be, for example, a cosine similarity, a dot product similarity, or the like. The comparison may be between each of the candidate listings and those portions of an anchor listing associated with explicit and/or implicit user feedback, or the entirety of the anchor listing. Accordingly, the ranking can be based on similarities for each of one or more scenes such as the similarities of the kitchens, bedrooms, bathrooms, and the like to the corresponding features of the anchor listing. In a further example, the comparison may be made between each of the candidate listings and a user profile of the user U, which may include visual preference information generated from aggregated visual preferences received based on interactions across one or more anchor listings.

At least some of the candidate listings can be displayed (step 308) based on the ranking performed at step 306. The display of the candidate listings can be presented in a dedicated section of the anchor listing such as a “similar listings” region, as a response to a user request to see similar listings to the anchor listing, or the like. The candidate listings that are displayed can be a subset of the candidate listings determined at step 304, for example the top three or top five most similar listings according to the rankings of the candidate listings. The candidate listings can be displayed, for example, as a combination of a thumbnail image, summary information for the respective listing such as price, location, number of rooms, square footage, combinations thereof, and the like, and a link to the full property listing.

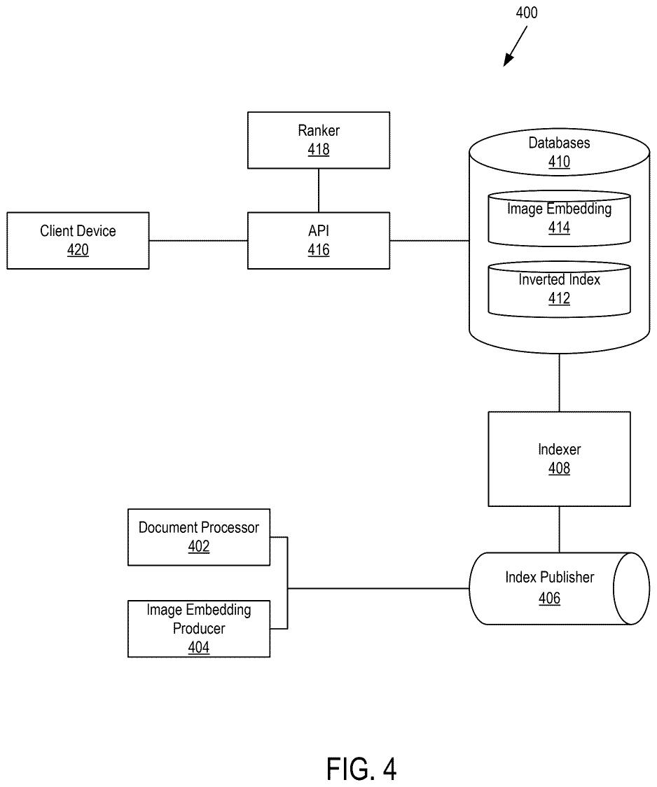

FIG. 4 shows example logical components of a property listing retrieval system according to an embodiment. Property listing retrieval system 400 includes document processor 402 and image embedding producer 404 feeding into index publisher 406. Indexer 408 writes the published index information into database 410, which includes inverted index 412 and image embedding 414. An application programming interface (API) 416 communicates with the database 410 to retrieve property listings. API 416 can further call ranker 418 to determine a ranking of the retrieved property listings for presentation on client device 420.

Property listing retrieval system 400 is configured to retrieve property listings and to provide the property listings to client device 420 for viewing. The property listing retrieval system 400 can retrieve the property listings and rank the property listings for presentation based on an anchor listing selected by the user of the client device 420, user data of the user of the client device 420 such as a user profile, combinations thereof, or the like.

Document processor 402 is configured to obtain index information for a property listing. The index information obtained by the document processor 402 can include, for example, data such as the square footage, numbers of bedrooms and/or bathrooms, location, list prices, and other such data regarding the property listing. The document processor 402 can further process textual descriptions of the property to obtain index information, such as descriptions of the features of the property such as amenities, characteristics of the neighborhood, and the like based on the content of the textual portion of the property listing. In some instances, the index information can be used by structured feature engine 108 as the tabular metrics for retrieval and/or filtering of property listings. In some instances, the index information can provide the tabular characteristics that can be used in the determination of the set of candidate listings at 304.

Image embedding producer 404 is configured to generate image embeddings for the images included in the property listing. The image embeddings can include representations of the image and/or features thereof such as a vector representation, captions describing the image, an identification of the scene the image is associated with, and the like. The image embedding producer 404 can include a model such as a CLIP model. Image embedding producer 404 can further associate the images with particular scene, for example using the CLIP model. The scenes can correspond to, for example, a predetermined set of key rooms having significant relevance to user preferences. The number of different scenes images can be classified into can be selected based on coverage, such as the number of listings including a particular room or feature that could be considered a scene, relevance of the scene to users, for example based on dwell time on certain images, available computational resources compared to burdens associated with performing the classifications, and the like. In some instances, the image embedding producer generates the image representations stored in image representation database 102. The image embeddings from image embedding producer 404 can be used in one or both of determining sets of candidate listings at step 304 and/or the ranking of the candidate listings at 306.

Index publisher 406 is configured to generate an index entry based on the outputs of document processor 402 and image embedding producer 404. The index entry includes the index information of the property listing and the image embeddings for said property listing. Indexer 408 is configured to write the index entry generated by index publisher 406 into the database 410, providing the index entries in a format suitable for storage in database 410. The formatting of the index entries can facilitate the search and retrieval of the listing from database 410, for example during the determination of candidate property listings at step 304 of method 300. Indexer 408 can write both the index information and the image embeddings to database 410, allowing the image embeddings to be retrieved alongside the property listing. Retrieving stored image embeddings alongside the property listing can make the image embeddings available for use more quickly. The quicker return of the image embeddings can in turn allow the determination of candidate property listings at step 304 and/or ranking of the candidate listings at 306 to be performed more quickly, e.g., in realtime in response to user view of a particular page at which similar home listings are to be displayed.

Database 410 is one or more memories storing index entries for each of a plurality of property listings. The database 410 can be configured to store the index entries in an inverted index 412 from which the property listings can be retrieved. Inverted index 412 includes the attributes of the respective listings, such as the respective locations, numbers of rooms, square footage, price, and other such attributes. Inverted index 412 can be used for pre-filtering of candidate property listings to reduce the number of property listings for which similarity is determined using the image embeddings. This can reduce the number of listings for which the image embeddings are referenced to determine similarity, thus reducing potential storage and processing burdens associated with the determinations of similarity and to increase the speed of response in providing the similar property listings to the client device 420 (an example of the computing device 10 of FIG. 1). The database 410 can further store the image embeddings 414 including images, representations of images or scenes composed thereof, embeddings for such images, such as associations of images with particular scenes such as key rooms, aggregations corresponding to such scenes, or the like. The contents of database 410 can be used for the determination of the set of candidate listings at step 304 and/or the ranking of the candidate listings at step 306.

API 416 provides an interface through which client device 420 can request similar property listings from the property listing retrieval system 400. API 416 can receive information for the determination of similar property listings from client device 420, such as an identification of an anchor listing, an identity of the user, a user profile, clickstream or other interaction data, and the like. API 416 can be an interface accessible through a website, by way of a dedicated application such as a mobile phone or tablet application, or the like. API 416 can provide the requested similar property listings to the client device 420 for display, for example as step 308 of method 300.

Ranker 418 is configured to rank the property listings obtained from database 410, for example to perform the ranking of candidate property listings at step 306 of method 300. The ranker 418 can use a model, such as a pointwise Catboost classifier model, to score property listings based on similarity to the anchor listing. The similarity can include similarity regarding tabular characteristics of the property listing such as location, price, square footage, numbers of bedrooms and/or bathrooms and the like, along with similarity scores for the image representations associated with the respective listings compared to the image representations of the anchor listing. The similarity of the image representations can be determined for each of a plurality of scene types, such as specific rooms such as the kitchen, master bedroom, master bathroom, or the like. In an embodiment, the similarity can be determined based on difference features between a property listing being ranked and the anchor listing.

In an embodiment, the model used in ranker 418 can be trained over the course of a user session, for example treating property listings selected by the user (visited, saved as a favorite, etc.) as positive examples and listings not selected as negative examples to adjust the parameters used to determine the similarity scores for the listings relative to the anchor listing. The training of the model can be specific to the user session, can be used to build a profile specific to the user and applied in further searches by the user, or the like.

In an embodiment, the ranker 418 can further incorporate additional data sources when determining the rankings of property listings for API 416 to provide to client device 420. The additional data sources can include, for example, a user profile of the user of the client device 420, one or more additional property listings such as listings saved as favorites, listings the user has previously interacted with, or the like. The additional data sources can enrich the determination of the rankings, for example by providing weighting for certain scenes, informing the identification of particular features of relevance, or the like. In an embodiment, the user profile can include user visual preferences as determined in steps 202-208 of method 200 as described above and shown in FIG. 2.

Client device 420 is a device requesting the listings from property listing retrieval system 400. Client device 420 can be, for example, a mobile phone or tablet device executing an application to interface with API 416, a computer, mobile phone, or tablet device accessing a website where API 416 is provided, or the like. In an embodiment, the client device 420 can provide a selection of a property listing serving as an anchor listing for the retrieval and determination of similarity, for example by accessing the listing, receiving a request for similar property listings, saving the listing as a favorite listing, or the like. Client device 420 can request property listings similar to the anchor listing by way of the API 416, and the client device can be provided with said similar property listings by way of the API 416 for display of the property listings to a user.

FIG. 5 shows an example interface in which aspects of the present disclosure may be implemented to receive explicit user feedback regarding visual preferences in a listing. Interface 500 can be presented on a user device 10 used by a user U. The interface 500 includes a listing 502, which can include listing interactable 503, one or more listing images 504, text interaction field 506, and listing details 510.

Listing 502 is a property listing being displayed to a user, for example as a response to a user query or selection, as selected for display at step 202 of method 200, or the like. Listing 502 can include one or more listing interactables 503, such as a “like” button, a “save” button, a “dislike” or “do not show this listing” button, or the like. The listing interactable 503 can provide user sentiment feedback regarding the listing as a whole. For example, when the property is saved to a list for future use or action, identified as being liked by the user, etc., the user interaction can be understood as positive user feedback, and as negative user feedback when a “dislike” or “do not show this listing” button is interacted with by the user. The feedback can be applied to characteristics of the entire listing when the listing interactable 503 is interacted with. Listing 502 can also include listing details 510 which can include one or both of tabular data for the property such as address, price, size details such as bedrooms, bathrooms, square footage, etc. and narrative text describing the property listing 502.

The listing 502 includes images 504 showing views of the property or portions thereof. Each of images 504 can be associated with a scene and/or particular features, for example based on image representations from image representation database 102, embeddings determined by image embedding producer and stored in database 410 as image embedding 414, or the like. One or more of the images 504 can include one or more image interactables 505, such as a “like” or “dislike” button. The image interactable(s) 505 can be used to provide feedback specific to the individual image. The feedback provided through the image interactable 505 can be applied to specific embeddings of the image 504 the image interactable 505 is provided in. For example, for the image 504 of FIG. 5 showing the exterior of the house, feedback from interaction with the image interactable 505 can be applied to user preferences or the weighting for the exterior view scene and/or features of the image for which embeddings are present, such as “attached garage.”

Text interaction field 506 can include a textual prompt and accept input of user text. The textual prompt is a prompt eliciting a textual response from the user. The textual prompt can be, for example, requesting a user's impressions of certain features from within one or more of the images 504 of the listing 502. In an embodiment, the textual prompt can directly reference specific images 504 or features thereof. In an embodiment, the textual prompt can elicit further feedback regarding one or more interactions with image interactables 505, for example as shown in FIG. 5. In an embodiment, the textual prompt can be generated by a large language model (LLM), and responses may be processed by such an LLM to obtain sentiment and meaning information, as discussed herein. In an embodiment, the textual prompt can be generated by multimodal LLM 106.

In an embodiment, the textual prompt 504 can be generated based on the user profile, for example to refine certain preferences, resolve potential inconsistencies or clarify past preference indications by the user, or the like. The textual input from a user can be received by, for example, keyboard or touchscreen inputs, speech-to-text, or the like. The textual input provides feedback responsive to the textual prompt and any images referenced therein. The textual input can be processed by, for example, multimodal LLM 106 to determine positive or negative feedback and associated image embeddings such as scenes, features or objects in the referenced image 504, etc. In the example shown in FIG. 5, the textual prompt shown in text input field 506 states “What do you like about the specific feature(s).” The response to this textual prompt can be processed by multimodal LLM 106 to associate feedback with particular image embeddings. For example, based on the textual response shown in FIG. 5, the kitchen scene and a feature embedding for the column feature of the exterior can each be attributed positive feedback through the listing interactable 503 or the associated image interactables 505 for the exterior and kitchen view shown in listing 502.

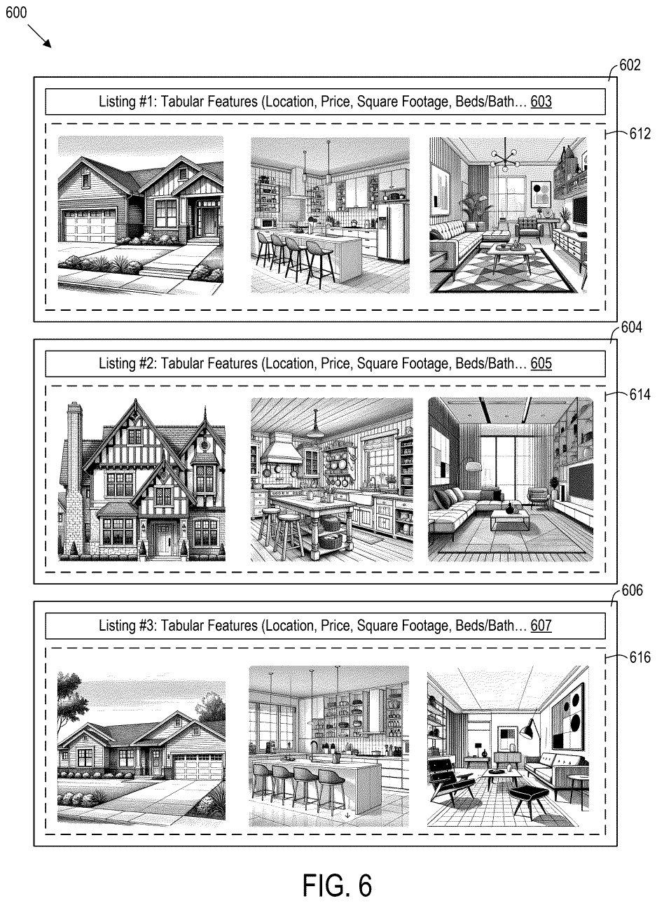

FIG. 6 shows an example collection of datasets of property listings including tabular listing criteria and images from which determinations of visual similarity may be drawn. Property listings 600 include a first property listing 602 including first tabular features 603 and first set of images 612, second property listing 604 including second tabular features 605 and second set of images 614, and third property listing 606 including third tabular features 607 and third set of images 616.

The respective tabular features 603, 605, 607 can include the location, price, square footage, numbers of bedrooms and bathrooms and other such features of the respective property listings. The tabular features 603, 605, 607 can be, for example, determined by document processor 402 and stored in inverted index 412. The tabular features 603, 605, 607 can be used, for example, in determining candidate listings at step 304 of the method 300. In an embodiment, the tabular features 603, 605, 607 can be used in retrieval or filtering of property listings and/or determination of similarity as performed by structured feature engine 108.

Each of the property listings 602, 604, 606 includes a corresponding set of images 612, 614, 616. Each image of the sets of images 612, 614, 616 can have associated image embeddings, for example identifying the scene the image is associated with, identifying specific features or objects in the image, providing a representation of the image such as a vector representation, etc. The image embeddings can be stored in, for example, in image representation database 102 of FIG. 1, or in image embedding 414 of database 410 in the example architecture of FIG. 4. The image embeddings can be used, for example, by a ranker 418 to rank the similarity of property listings 602, 604, 606 to an anchor property and/or a user profile of user visual preferences, for example when ranking property listings for display at step 210 of the method 200, or in the ranking of candidate property listings at step 306 of the method 300.

FIG. 7 shows an example flow diagram of processing user preferences derived from one or more anchor listings to generate similar listings for presentment to a user. User U can provide input of one or more of a selection of an anchor listing 702, user visual preferences 710, and tabular characteristic preferences 722.

Anchor listing 702 is a property listing selected by user U for which similar property listings are to be obtained. The anchor listing 702 can be a listing currently being viewed by the user, a listing selected by the user for use as the anchor listing 702, a listing saved by the user, or the like. The anchor listing includes tabular data for the listing and images. The images can include anchor listing embeddings 704, for example identifying the images as being part of a scene, identifying features of the image and/or objects present in the image, and the like.

User visual preferences 710 can be stated or implied visual preferences of the user. The user visual preferences can be, for example, a user profile, session data from the user, or the like. The user visual preferences can be obtained through user interactions with images, for example according to steps 202-208 of method 200. The user visual preferences can be, for example, vector data representative of image characteristics corresponding to the user preferences. The user visual preferences can include preferences for particular scenes, features, or elements. The user visual preferences 710 can be used to determine anchor listing embeddings 704 having particular relevance to the user, thus generating a subselection of embeddings 712. In an embodiment, the subselection of embeddings 712 can be provided as weightings for particular embeddings for use in calculating distance or similarity between candidate listings 724 and the anchor listing 702.

Tabular user preferences 722 can also be obtained from the user U. The tabular user preferences 722 can be obtained from a user query such as a search from property listings, from the tabular characteristics of anchor listing 702, or the like. The tabular user preferences 722 are user preferences regarding the tabular characteristics of property listings such as price, location, square footage, numbers of bedrooms and/or bathrooms, and the like. The tabular user preferences can be used to perform retrieval on available listings 720 to arrive at candidate listings 724. Candidate listings 724 are listings retrieved from one or more databases of the available listings 720 based on having tabular features that match or are sufficiently similar (within predetermined tolerance ranges, etc.) the tabular user preferences 722. Each of candidate listings 724 includes one or more images, the images each having corresponding precomputed embeddings 726 representative of the respective images, features or objects of the respective images, associations of the respective images with scenes, etc. The precomputed embeddings 726 can be, for example, generated by image embedding producer 404 and stored in image embedding 414 of database 410 as shown in FIG. 4.

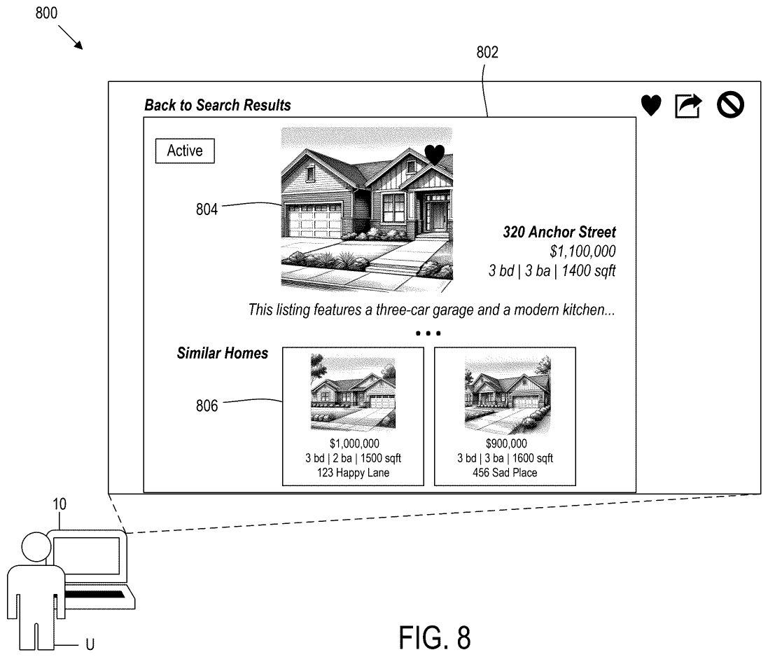

Embedding distance calculations 730 can be determined for each candidate listing 724 based on similarity, such as a cosine distance, between the precomputed embeddings 726 of the respective candidate listing 724 and the subselection of embeddings 712. The embedding distance calculations reflect the similarity of each candidate listing 724 to the anchor listing 702 and the user visual preferences 710. The embedding distance calculations 730 can be used to rank the candidate listings by similarity to the anchor listing 702 and user visual preferences 710, resulting in ranked candidates 740. The ranked candidates 740 having the most similarity to the anchor listing 702 and user visual preferences 710 can be displayed to the user, for example in user interface 800 as shown in FIG. 8 and described below.

FIG. 8 shows an example user interface in which property listings having similar visual characteristics to those associated with a user profile may be presented. User interface 800 can be presented to user U on a user device 10. The user interface includes similar homes display 802. Similar home display 802 can include anchor listing 804 and similar listing views 806. Similar homes display 802 can be presented as part of presentation of a property listing in the user interface, as a separate view requested by the user through interaction with the listing or the like. Anchor listing 804 can be a property listing used to determine the similar homes for display. Anchor listing 804 can be a listing currently being viewed by a user, a listing the user has requested similar homes for, or the like. Anchor listing 804 includes tabular features and one or more images having corresponding image embeddings (scene, particular features or objects, etc.), for example as determined by image embedding producer 404, from image representation database 102, or the like. The tabular features and/or image embeddings of anchor listing 804 can be used in determining a set of candidate listings at step 304 of method 300, and ranking of the candidate listings at step 306. The top ranked candidate listing(s) following the ranking at step 306 of method 300 can be provided as the similar listing views 806. The similar listing views 806 can be provided as a series of summarized listings, for example showing an image of the property listing or a thumbnail thereof along with at least some tabular features such as the price, address, numbers of bedrooms and bathrooms, square footage, etc. In some instances, the similar listing views 806 can be selected based at least in part on user visual preferences, such as the user visual preferences 710. The user visual preferences used to select listings for inclusion as similar listing views 806 can include, for example, session data and/or a user profile. The user profile can be determined, for example, according to steps 202-208 of method 210.

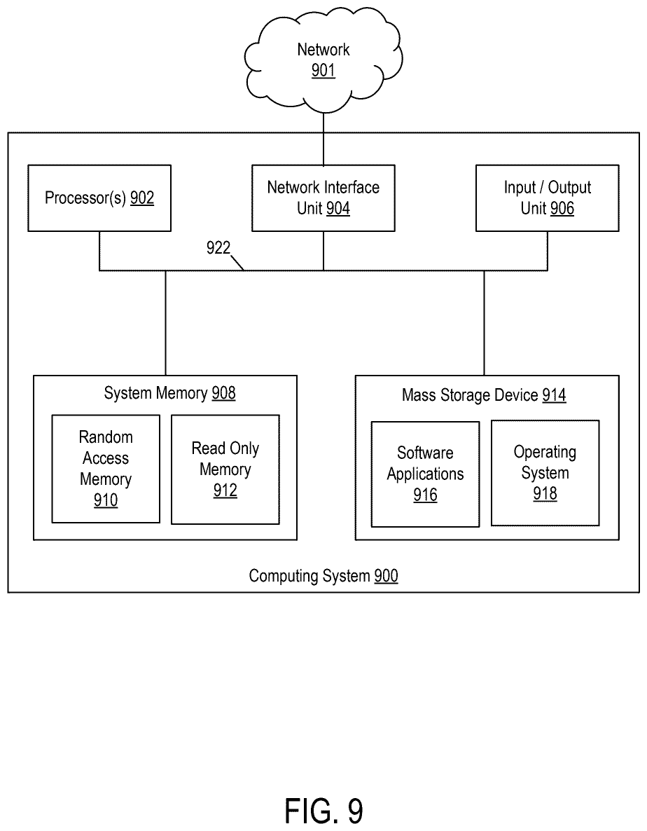

FIG. 9 illustrates an example block diagram of a virtual or physical computing system 1000. The computing system may be used within the example computing environment for the property listing presentation system of FIG. 1. That is, one or more aspects of the computing system 900 can be used to implement the system and processes described herein. In the embodiment shown, the computing system 900 includes one or more processors 902, a system memory 908, and a system bus 922 that couples the system memory 908 to the one or more processors 902. The system memory 908 includes RAM (Random Access Memory) 910 and ROM (Read-Only Memory) 912. A basic input/output system that contains the basic routines that help to transfer information between elements within the computing system 900, such as during startup, is stored in the ROM 912. The computing system 900 further includes a mass storage device 914. The mass storage device 914 is able to store software instructions and data. The one or more processors 902 can be one or more central processing units or other processors.

The mass storage device 914 is connected to the one or more processors 902 through a mass storage controller (not shown) connected to the system bus 922. The mass storage device 914 and its associated computer-readable data storage media provide non-volatile, non-transitory storage for the computing system 900. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1100.

According to various embodiments of the invention, the computing system 900 may operate in a networked environment using logical connections to remote network devices through the network 901. The network 901 is a computer network, such as an enterprise intranet and/or the Internet. The network 901 can include a LAN, a Wide Area Network (WAN), the internet, wireless transmission mediums, wired transmission mediums, other networks, and combinations thereof. The computing system 900 may connect to the network 901 through a network interface unit 904 connected to the system bus 922. It should be appreciated that the network interface unit 904 may also be utilized to connect to other types of networks and remote computing systems. The computing system 900 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the computing system 900 can store software instructions and data. The software instructions include an operating system 918 suitable for controlling the operation of the computing system 900. The mass storage device 914 and/or the RAM 910 also store software instructions, that when executed by the one or more processors 902, cause one or more of the systems, devices, or components described herein to provide functionality described herein. For example, the mass storage device 914 and/or the RAM 910 can store software instructions that, when executed by the one or more processors 902, cause the computing system 900 to receive and execute managing network access control and build system processes.

Although illustrated as being components of a single computing environment 900, the components of the computing environment can be spread across multiple computing environments. For example, one or more of instructions or data stored on the memory 908 may be stored partially or entirely in a separate computing environment that is accessed over a network.

Techniques of the multimodal selection processes described herein have been empirically compared to prior techniques for generating suggested listings. For example, the use of a visual preference engine 104, using the techniques of FIGS. 2-3 to generate either distance-based or scene-based recommendations using visual similarity assessments, was compared against baseline distance-based and scene-based candidate generation processes. The results are shown below in Table 1 relative to the normalized discounted cumulative gain (NDCG) ranking metric at different numbers of results.

TABLE 1
Quantitative Evaluation of Multimodal Candidate Generation

| | Candidate | | | |
|---|---|---|---|---|
| Model | Generation | NDCG@1 | NDGC@5 | NDGC@10 |
| Baseline | Distance Based | 9.20 | 11.38 | 13.08 |
| Baseline | Scene Based | 11.56 | 12.66 | 13.78 |
| Scene Model | Distance Based | 9.84 | 11.96 | 13.64 |
| Scene Model | Scene Based | 12.03 | 13.06 | 14.19 |

Table 1 illustrates that the use of such multimodal candidate generation is better able to identify provide gain in terms of user interactivity with presented listings. Accordingly, modifying a similarity ranking system to incorporate aspects of visual similarity can improve the relevance of results provided to the user. In addition to the above experimental results, it was observed that a 6.36% global lift in user engagement was observed in an online A/B test using scene embeddings in candidate generation and ranking to determine the “similar homes” presented in a user interface analogous to the one shown in FIG. 8. Overall user engagement increased 0.05% as well.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, two or more operations can be performed as a single operation, additional operations can be performed, and disclosed operations can be excluded without departing from the present disclosure. Further, certain operation can be accomplished via one or more sub-operations. The disclosed methods and processes, or aspects of the disclosed methods and processes, can be repeated. Moreover, although certain operations are described as being performed by certain components, other components may perform such operations, depending on the embodiment, as will be understood by those having ordinary skill in the art.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. A system for presentation of property listings, comprising:
at least one processor; and
at least one memory, the at least one memory storing a database containing a plurality of image representations, each of the plurality of image representations associated with one of a plurality of property listings, the at least one memory further storing instructions that, when executed, cause the at least one processor to:
direct presentation of an interface on a display, the interface including one or more views;
receive an interaction of a user with said one or more views;
determine a user preference based on the interaction;
update a profile of the user based on the user preference; and
direct presentation of one or more property listings of the plurality of property listings to the user based on the profile of the user and one or more of the plurality of image representations.

2. The system of claim 1, wherein the presentation of the one or more property listings is further based on one or more structured features input by the user.

3. The system of claim 1, wherein the instructions further cause the at least one processor to determine a textual prompt and direct presentation of the textual prompt to the user.

4. The system of claim 3, wherein the instructions further cause the at least one processor to update the profile of the user based on a received response to the textual prompt.

5. The system of claim 1, wherein the one or more property listings are results responsive to a property listing search query input by the user.

6. The system of claim 5, wherein the presentation of the one or more property listings is ordered based on profile of the user and one or more of the plurality of image representations.

7. The system of claim 1, wherein one or more of the plurality of image representations of the database are vector representations of one or more images.

8. The system of claim 1, wherein the instructions cause the processor to determine a vector based on one or more of the image representations of the database.

9. The system of claim 1, wherein the instructions cause the processor to determine a cosine similarity between the profile of the user and the image representations, and the presentation of one or more property listings of the plurality of property listings to the user is based on the cosine similarity between the profile of the user and the image representations.

10. A method for presentation of property listings, comprising:
providing, in a memory, a database containing a plurality of image representations, each of the plurality of image representations associated with one of a plurality of property listings;
presenting an interface on a display, the interface including one or more views;
receiving an interaction of a user with said one or more views;
determining, using a processor, a user preference based on the interaction;
updating, using the processor, a profile of the user based on the user preference; and
presenting one or more property listings of the plurality of property listings to the user based on the profile of the user and one or more of the plurality of image representations.

11. The method of claim 10, wherein the presenting the one or more property listings is further based on one or more structured features input by the user.

12. The method of claim 10, further comprising determining, using the processor, a textual prompt and presenting the textual prompt to the user.

13. The method of claim 12, further comprising updating the profile of the user based on a received response to the textual prompt.

14. The method of claim 10, wherein the one or more property listings are results responsive to a property listing search query input by the user.

15. The method of claim 10, further comprising determining a cosine similarity between the profile of the user and the image representations, and wherein the presenting the one or more property listings of the plurality of property listings to the user is based on the cosine similarity between the profile of the user and the image representations.

16. A system for retrieval of property listings, comprising:
at least one processor; and
at least one memory, the at least one memory storing instructions that, when executed, cause the at least one processor to:
receive an anchor property listing;
determine a plurality of candidate property listings;
assign rankings the candidate property listings based on a similarity of image representations associated with respective candidate property listings to image representations of the anchor property listing; and
provide at least some of the candidate property listings to a client device based on the rankings.

17. The system of claim 16, wherein the instructions cause the processor to determine the plurality of candidate property listings by retrieving property listings from a database based on said property listings having tabular characteristics in a range based on corresponding tabular characteristics of the anchor listing.

18. The system of claim 16, wherein the instructions cause the processor to assign the rankings of the candidate property listings using a Catboost classifier.

19. The system of claim 16, wherein the least some of the candidate property listings to a client device based on the rankings are a predetermined number of property listings ranked as having a highest similarity to the anchor listing.

20. The system of claim 16, wherein the instructions further cause the at least one processor to process one or more images associated with a property listing to generate one or more of the image representations associated with said property listing, and store the property listing and the one or more image representations associated with said property listing to a database.
